(19) United States
(12) Patent Application Publication
(10) Pub. No.: US 2024/0320933 A1
(43) Pub. Date: Sep. 26, 2024

(54) SYSTEMS AND METHODS FOR VISUALIZING FLOOR DATA IN MIXED REALITY ENVIRONMENT

(71) Applicant: FARO Technologies, Inc., Lake Mary, FL (US)

(72) Inventors: Daniel Korgel, Bochum (DE); Angelo Wostal, Ahlen (DE); Qiang Fu, Montreal (CA); Yunhua Wang, Korntal-Münchingen (DE); Tassilo Heling, Korntal-Münchingen (DE)

(21) Appl. No.: 18/609,920

(22) Filed: Mar. 19, 2024

Related U.S. Application Data
(60) Provisional application No. 63/453,456, filed on Mar. 20, 2023.

(51) Int. Cl. G06T 19/00; G06T 19/20

(52) U.S. Cl. CPC G06T 19/006; G06T 19/20; G06T 2219/2004

(57) ABSTRACT

Described herein are systems and methods for point cloud alignment with a floor plan or a video stream of an environment. The systems and method comprise overlaying a graphical representation of a point cloud onto an image of the floor plan and the video stream. The systems and methods further comprise aligning the graphical representation of the point cloud and the image of the floor plan with the video stream using a point alignment. The systems and methods further comprise displaying an update of the graphical representation based at least in part on a further point alignment or a movement alignment.

### CROSS-REFERENCE TO RELATED APPLICATIONS

This present application claims the benefit of U.S. Provisional Application Ser. No. 63/453,456, filed Mar. 20, 2023, the contents of which are incorporated herein by reference.

### BACKGROUND

The subject matter disclosed herein relates to use of a three-dimensional (3D) laser scanner time-of-flight (TOF) coordinate measurement device. A 3D laser scanner of this type steers a beam of light to a non-cooperative target such as a diffusely scattering surface of an object. A distance meter in the device measures a distance to the object, and angular encoders measure the angles of rotation of two axles in the device. The measured distance and two angles enable a processor in the device to determine the 3D coordinates of the target.

The TOF laser scanners are sometimes used in conjunction with a visualization post processing system to generate images of both the scanned data points and camera digital images. The TOF laser scanner data are combined with the camera digital images in order create a composite image that provides the operator, or another individual who is surveying the environment after the scan has been completed, with some context about where each of the scanned data points should be in the environment.

Although the combination of TOF laser scanners and visualization post processing systems are used to create a composite image of scanned data points and camera image data, the visualization post processing systems as disclosed herein incorporate additional contextual details that make it easier for the operator, surveyor or the like to better understand the relationship between the scanned data points and the environment.

### BRIEF DESCRIPTION

The current disclosure is directed to a method of aligning a point cloud with a floor plan or a live or recorded video stream of an environment. The disclosure is further directed a method that overlays a graphical representation of a point cloud onto an image of a floor plan and a video stream. The disclosure is further directed to a method that aligns the graphical representation of the point cloud and the image of the floor plan with the video stream using a point alignment. The disclosure is further directed to a method that displays an update of the graphical representation based at least in part on a further point alignment or a movement alignment. The disclosure is further directed to a method in which the graphical representation is a heatmap representation. The disclosure is further directed to a method in which the graphical representation is a cut-and-fill representation.

In some embodiments another method is disclosed for point cloud alignment with a floor plan or a video stream of an environment. The method comprises overlaying a graphical representation of a point cloud onto an image of a floor plan and the video stream. The method further comprises aligning the graphical representation of the point cloud with the image of the floor plan or the video stream based at least in part on a first point pair comprising a first virtual point associated with the point cloud and a first floor plan point associated with the image of the floor plan. The alignment of the graphical representation of the point cloud with the image of the floor plan or the video stream is further based at least in part on a second point pair comprising a second virtual point associated with the point cloud and a second floor plan point associated with the image of the floor plan. The alignment of the graphical representation of the point cloud with the image of the floor plan or the video stream is further based at least in part on a first distance between the first virtual point and the first floor plan point, and a second distance between the second virtual point and the second floor plan point. The method further comprises moving the point cloud relative to the image of the floor plan such that the first distance is minimized or such that the second distance is minimized, and displaying an update of the graphical representation based at least in part on a further point alignment or a movement alignment.

In some embodiments, a system for point cloud alignment with a floor plan or a video stream of an environment is disclosed. The system comprises at least one scanner, at least one memory storing instructions, and at least one processor. The at least one processor executes the instructions thereby causing the at least one processor to overlay a graphical representation of a point cloud onto an image of a floor plan and the video stream; align the graphical representation of the point cloud with the image of the floor plan or the video stream using a point alignment; and display an update of the graphical representation based at least in part on a further point alignment or a movement alignment.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of a laser scanner according to one or more embodiments described herein;

FIG. 2 is a side view of the laser scanner illustrating a method of measurement according to one or more embodiments described herein;

FIG. 3 is a schematic illustration of the optical, mechanical, and electrical components of the laser scanner according to one or more embodiments described herein;

FIG. 4 is a schematic illustration of the laser scanner of FIG. 1 according to one or more embodiments described herein;

FIG. 5 is a schematic illustration of a processing system for aligning and visualizing a point cloud according to one or more embodiments described herein;

FIG. 6 is a flow diagram of a method for aligning and visualizing a point cloud and floor plan of an environment using a movement alignment procedure according to one or more embodiments described herein;

FIG. 7 is a flow diagram of a point alignment method for aligning a point cloud and floor plan of an environment according to one or more embodiments described herein;

FIG. 8 is a flow diagram of a movement alignment method for aligning a point cloud and floor plan of an environment according to one or more embodiments described herein;

FIG. 9 is a flow diagram of a method for aligning and visualizing a point cloud and floor plan of an environment according to one or more embodiments described herein;

FIG. 10 is a flow diagram of a method for aligning and visualizing a point cloud and floor plan of an environment according to one or more embodiments described herein;

FIG. 11 depicts a floor plan of an environment according to one or more embodiments described herein; and

FIG. 12 depicts a point cloud overlaid on a floor plan according to one or more embodiments described herein.

FIG. 13 depicts a point cloud overlaid on a floor plan and virtual environment according to one or more embodiments described herein.

FIG. 14 depicts a point cloud overlaid on a floor plan and virtual environment according to one or more embodiments described herein.

FIG. 15 depicts a point cloud overlaid on a floor plan that visualizes parts of a floor that have a height that is outside of a floor flatness tolerance according to one or more embodiments described herein.

FIG. 16 depicts a point cloud overlaid on a video stream that visualizes parts of a floor that have a height that is outside of a floor flatness tolerance according to one or more embodiments described herein.

FIG. 17 is a schematic illustration of a processing system for implementing the presently described techniques according to one or more embodiments described herein.

The detailed description explains embodiments of the disclosure, together with advantages and features, by way of example with reference to the drawings.

### DETAILED DESCRIPTION

Embodiments described herein provide for aligning and visualizing a point cloud. Particularly, one or more embodiments described herein relate to performing one or more alignments to align a point cloud with an environment that the point cloud represents.

Three-dimensional (3D) coordinate measurement devices, such as laser scanners, are used to capture 3D data about an environment. The 3D data is presented on a device, such as a smartphone, tablet, heads-up display, etc., as a graphical representation. In some cases, the graphical representation of the point cloud is overlaid on a video stream of the environment that the point cloud represents. In such cases, the point cloud is not properly aligned with the environment. As a result, it is desirable to align the graphical representation of the point cloud with the environment.

Conventional techniques for aligning the graphical representation of the point cloud with the environment are often insufficient. For example, it is difficult to locate problematic areas in the physical world through visual inspection. Although augmented reality does aid in addressing this concern, the need for localizing the point cloud with the environment remains.

To address these and other shortcomings of the prior art, one or more embodiments described herein provide for aligning and visualizing a point cloud using a point alignment technique, a movement alignment technique, or some combination of the point alignment technique and the movement alignment technique. For example, the point alignment technique enables a user to select virtual points in the point cloud and corresponding points in the environment, and the representation of the point cloud can then be aligned to the environment using these selected points. As another example, the movement alignment technique enables a user to manually align the representation of the point cloud to the environment using movement instructions, such as gestures.

The techniques described herein provide one or more advantages over existing alignment solutions. For example, one or more embodiments described herein improve visualizing point clouds in an augmented reality environment. One or more embodiments described herein enable a user to overlay 3D measurement data in the form of a point cloud onto images or video (e.g., a video stream), wherein the overlay is used as a visual indication of scan-point coverage of a scanned environment, of features or attributes of the environment (e.g., floor flatness, defect detection, etc.), or the like. One or more embodiments described herein use colors to depict the features or attributes of the environment, such as deviations from an expected value.

One or more embodiments described herein utilize simultaneous localization and mapping algorithms (SLAM). SLAM is used to construct or update a map of an unknown environment while simultaneously tracking a user's or an agent's (e.g., a robot's) location within the unknown environment.

One or more embodiments described herein utilize augmented reality (AR). AR provides for enhancing the real physical world by delivering digital visual elements, sound, or other sensory stimuli (an “AR element”) via technology. For example, a user device (e.g., a smartphone, tablet computer, etc.) equipped with a camera and display are used to capture an image of an environment. In some cases, this includes using the camera to capture a live, real-time representation of an environment and displaying that representation on the display. An AR element is displayed on the display and associated with an object or feature of the environment. For example, the display digitally displays AR elements associated with a piece of equipment in the environment, as well as information about how to operate the particular piece of equipment in the environment. The AR element is digitally displayed on the display of the user device when the user device's camera captures images of the environment. As another example, a point cloud of 3D data is represented as an AR element on a real-time video stream of the environment. It is useful to know the location of the user device relative to the environment in order to accurately depict AR elements.

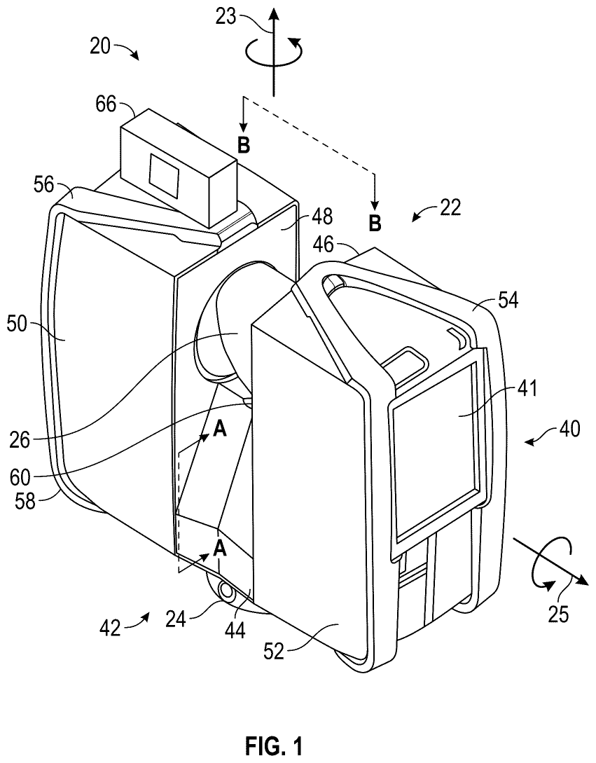

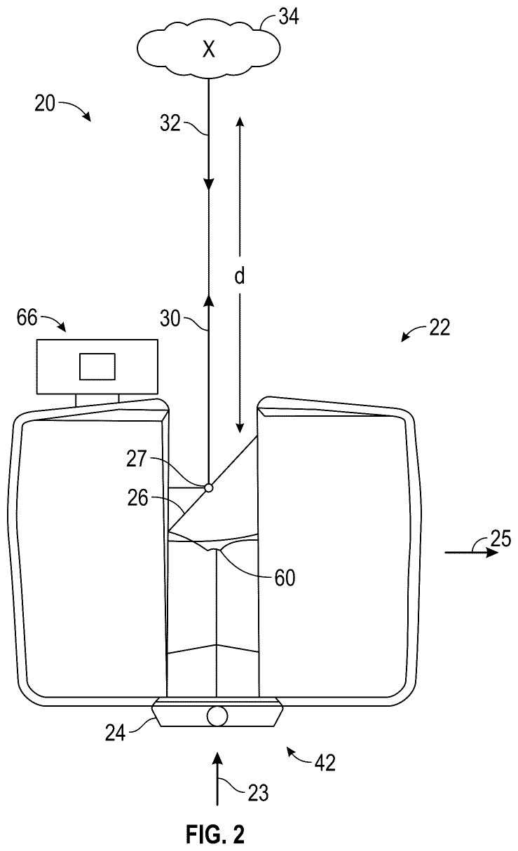

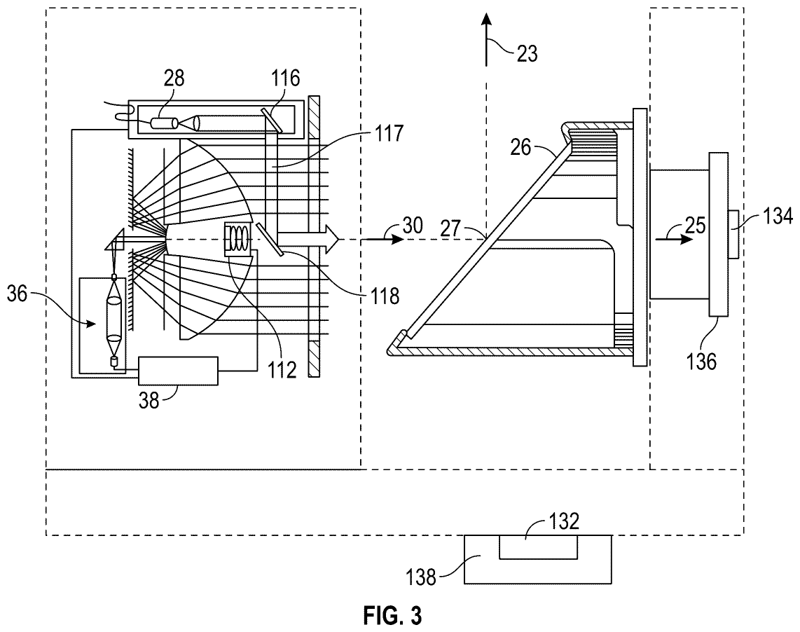

Referring now to FIGS. 1-3, a 3D coordinate measurement device, such as a laser scanner 20, is shown for optically scanning and measuring the environment surrounding the laser scanner 20 according to one or more embodiments described herein. The laser scanner 20 has a measuring head 22 and a base 24. The measuring head 22 is mounted on the base 24 such that the laser scanner 20 is rotated about a vertical axis 23. In one embodiment, the measuring head 22 includes a gimbal point 27 that is a center of rotation about the vertical axis 23 and a horizontal axis 25. The measuring head 22 has a rotary mirror 26, which rotates about the horizontal axis 25. The rotation about the vertical axis may be about the center of the base 24. The terms vertical axis and horizontal axis refer to the scanner in its normal upright position. A 3D coordinate measurement device is configured to operate on its side or upside down. So to avoid confusion, the term azimuth axis is used interchangeably with the term vertical axis, and the term zenith is used interchangeably with the term horizontal axis. The terms pan axis and standing axis are also used as an alternative to the term vertical axis.

The measuring head 22 is further provided with an electromagnetic radiation emitter, such as light emitter 28, for example, that emits an emitted light beam 30. In one embodiment, the emitted light beam 30 is a coherent light beam such as a laser beam. The laser beam may have a wavelength range of approximately 300 to 1600 nanometers, for example 790 nanometers, 905 nanometers, 1550 nm, or less than 400 nanometers. It should be appreciated that other electromagnetic radiation beams having greater or smaller wavelengths may also be used. The emitted light beam 30 is amplitude or intensity modulated, for example, with a sinusoidal waveform or with a rectangular waveform. The emitted light beam 30 is emitted by the light emitter 28 onto a beam steering unit, such as mirror 26, where it is deflected to the environment. A reflected light beam 32 is reflected from the environment by an object 34. The reflected or scattered light is intercepted by the rotary mirror 26 and directed into a light receiver 36. The directions of the emitted light beam 30 and the reflected light beam 32 result from the angular positions of the rotary mirror 26 and the measuring head 22 about the axes 25 and 23, respectively. These angular positions in turn depend on the corresponding rotary drives or motors.

Coupled to the light emitter 28 and the light receiver 36 is a controller 38. The controller 38 determines, for a multitude of measuring points X, a corresponding number of distances d between the laser scanner 20 and the points X on object 34. The distance to a particular point X is determined based at least in part on the speed of light in air through which electromagnetic radiation propagates from the device to the object point X. In one embodiment the phase shift of modulation in light emitted by the laser scanner 20 and the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, cₐᵢᵣ=c/n. A laser scanner of the type discussed herein is based on the time-of-flight (TOF) of the light in the air (the round-trip time for the light to travel from the device to the object and back to the device). Examples of TOF scanners include scanners that measure round trip time using the time interval between emitted and returning pulses (pulsed TOF scanners), scanners that modulate light sinusoidally and measure phase shift of the returning light (phase-based scanners), as well as many other types. A method of measuring distance based on the time-of-flight of light depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based on one known length and two known angles of a triangle. The method of triangulation, therefore, does not directly depend on the speed of light in air.

In one mode of operation, the scanning of the volume around the laser scanner 20 takes place by rotating the rotary mirror 26 relatively quickly about axis 25 while rotating the measuring head 22 relatively slowly about axis 23, thereby moving the assembly in a spiral pattern. In an exemplary embodiment, the rotary mirror rotates at a maximum speed of 5820 revolutions per minute. For such a scan, the gimbal point 27 defines the origin of the local stationary reference system. The base 24 rests in this local stationary reference system.

In addition to measuring a distance d from the gimbal point 27 to an object point X, the laser scanner 20 also collects gray-scale information related to the received optical power (equivalent to the term “brightness”). In some exemplary embodiments, the gray-scale value is determined based at least in part, on an integration of a bandpass-filtered and amplified signal in the light receiver 36 over a measuring period attributed to the object point X.

The measuring head 22 includes a display device 40 integrated into the laser scanner 20. The display device 40 further includes a graphical touch screen 41, as shown in FIG. 1, which allows the operator to set the parameters or initiate the operation of the laser scanner 20. For example, the screen 41 has a user interface that allows the operator to provide measurement instructions to the device, and the screen also is configured to display measurement results.

The laser scanner 20 includes a carrying structure 42 that provides a frame for the measuring head 22 and a platform for attaching the components of the laser scanner 20. In one embodiment, the carrying structure 42 is made from a metal such as aluminum. The carrying structure 42 includes a traverse member 44 having a pair of walls 46, 48 on opposing ends. The walls 46, 48 are parallel to each other and extend in a direction opposite the base 24. Shells 50, 52 are coupled to the walls 46, 48 and cover the components of the laser scanner 20. In the exemplary embodiment, the shells 50, 52 are made from a plastic material, such as polycarbonate or polyethylene for example. The shells 50, 52 cooperate with the walls 46, 48 to form a housing for the laser scanner 20.

On an end of the shells 50, 52 opposite the walls 46, 48 a pair of yokes 54, 56 are arranged to partially cover the respective shells 50, 52. In the exemplary embodiment, the yokes 54, 56 are made from a suitably durable material, such as aluminum for example, that assists in protecting the shells 50, 52 during transport and operation. The yokes 54, 56 each include a first arm portion 58 that is coupled, such as with a fastener for example, to the traverse 44 adjacent the base 24. The arm portion 58 for each yoke 54, 56 extends from the traverse 44 obliquely to an outer corner of the respective shell 50, 52. From the outer corner of the shell, the yokes 54, 56 extend along the side edge of the shell to an opposite outer corner of the shell. Each yoke 54, 56 further includes a second arm portion that extends obliquely to the walls 46, 48. It should be appreciated that in some embodiments, that the yokes 54, 56 couple to the traverse 42, the walls 46, 48 and the shells 50, 54 at multiple locations.

The pair of yokes 54, 56 cooperate to circumscribe a convex space within which the two shells 50, 52 are arranged. In the exemplary embodiment, the yokes 54, 56 cooperate to cover all of the outer edges of the shells 50, 54, while the top and bottom arm portions project over at least a portion of the top and bottom edges of the shells 50, 52. This provides advantages in protecting the shells 50, 52 and the measuring head 22 from damage during transportation and operation. In other embodiments, the yokes 54, 56 include additional features, such as handles to facilitate the carrying of the laser scanner 20 or attachment points for accessories for example.

On top of the traverse 44, a prism 60 is provided. The prism extends parallel to the walls 46, 48. In the exemplary embodiment, the prism 60 is integrally formed as part of the carrying structure 42. In other embodiments, the prism 60 is a separate component that is coupled to the traverse 44. When the mirror 26 rotates, during each rotation the mirror 26 directs the emitted light beam 30 onto the traverse 44 and the prism 60. Due to non-linearities in the electronic components, for example in the light receiver 36, the measured distances d depend on signal strength, which may be measured in optical power entering the scanner or optical power entering optical detectors within the light receiver 36, for example. In an embodiment, a distance correction is stored in the scanner as a function (possibly a nonlinear function) of distance to a measured point and optical power (generally unscaled quantity of light power sometimes referred to as “brightness”) returned from the measured point and sent to an optical detector in the light receiver 36. Since the prism 60 is at a known distance from the gimbal point 27, the measured optical power level of light reflected by the prism 60 is used to correct distance measurements for other measured points, thereby allowing for compensation to correct for the effects of environmental variables such as temperature. In the exemplary embodiment, the resulting correction of distance is performed by the controller 38.

In an embodiment, the base 24 is coupled to a swivel assembly (not shown) such as that described in commonly owned U.S. Pat. No. 8,705,012 ('012), which is incorporated by reference herein. The swivel assembly is housed within the carrying structure 42 and includes a motor 138 that is configured to rotate the measuring head 22 about the axis 23. In an embodiment, the angular/rotational position of the measuring head 22 about the axis 23 is measured by angular encoder 134.

An auxiliary image acquisition device 66 may be a device that captures and measures a parameter associated with the scanned area or the scanned object and provides a signal representing the measured quantities over an image acquisition area. In some embodiments the auxiliary image acquisition device 66 is a pyrometer, a thermal imager, an ionizing radiation detector, or a millimeter-wave detector. In an embodiment, the auxiliary image acquisition device 66 is a color camera.

In an embodiment, a central color camera (first image acquisition device) 112 is located internally to the scanner and has the same optical axis as the 3D scanner device. In this embodiment, the first image acquisition device 112 is integrated into the measuring head 22 and arranged to acquire images along the same optical pathway as emitted light beam 30 and reflected light beam 32. In this embodiment, the light from the light emitter 28 reflects off a fixed mirror 116 and travels to dichroic beam-splitter 118 that reflects the light 117 from the light emitter 28 onto the rotary mirror 26. In an embodiment, the mirror 26 is rotated by a motor 136 and the angular/rotational position of the mirror is measured by angular encoder 134. The dichroic beam-splitter 118 allows light to pass through at wavelengths different than the wavelength of light 117. In some embodiments the light emitter 28 is a near infrared laser light (for example, light at wavelengths of 780 nm or 1250 nm), with the dichroic beam-splitter 118 configured to reflect the infrared laser light while allowing visible light (e.g., wavelengths of 400 to 700 nm) to transmit through. In other embodiments, the determination of whether the light passes through the beam-splitter 118 or is reflected depends on the polarization of the light. The digital camera 112 obtains 2D images of the scanned area to capture color data to add to the scanned image. In the case of a built-in color camera having an optical axis coincident with that of the 3D scanning device, the direction of the camera view is easily obtained by simply adjusting the steering mechanisms of the scanner—for example, by adjusting the azimuth angle about the axis 23 and by steering the mirror 26 about the axis 25.

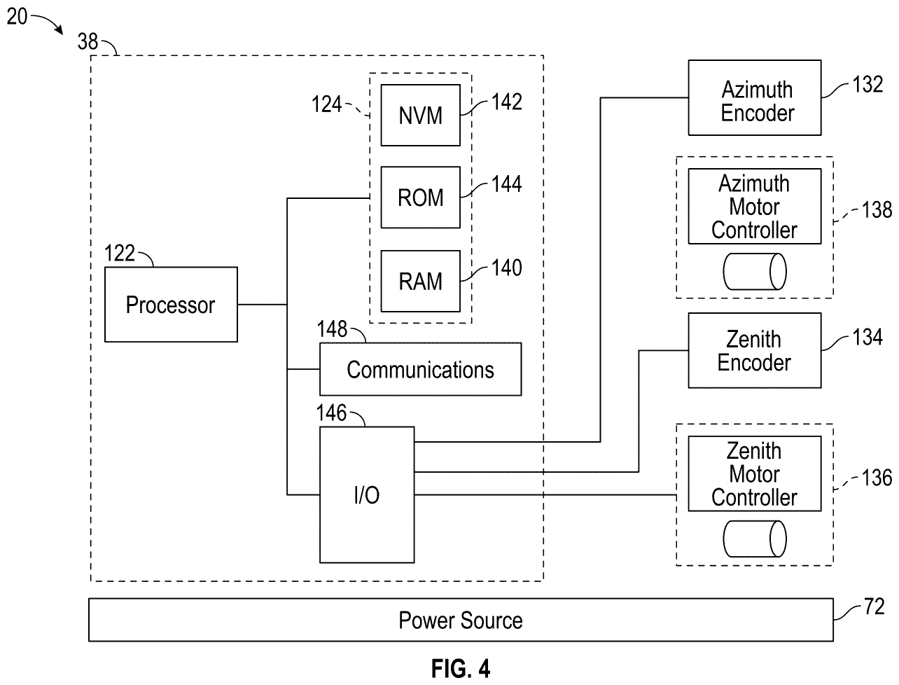

Referring now to FIG. 4 with continuing reference to FIGS. 1-3, elements are shown of the laser scanner 20. Controller 38 is a suitable electronic device capable of accepting data and instructions, executing the instructions to process the data, and presenting the results. The controller 38 includes one or more processing elements 122. In some embodiments, the one or more processing elements 122 comprise microprocessors, field programmable gate arrays (FPGAs), digital signal processors (DSPs), and generally any device capable of performing computing functions. The one or more processing elements 122 have access to memory 124 for storing information.

Controller 38 is capable of converting the analog voltage or current level provided by light receiver 36 into a digital signal to determine a distance from the laser scanner 20 to an object in the environment. Controller 38 uses the digital signals that act as input to various processes for controlling the laser scanner 20. The digital signals represent one or more laser scanner 20 data including but not limited to distance to an object, images of the environment, images acquired by panoramic camera 126, angular/rotational measurements by a first or azimuth encoder 132, and angular/rotational measurements by a second axis or zenith encoder 134.

In general, controller 38 accepts data from encoders 132, 134, light receiver 36, light source 28, and panoramic camera 126 and is given certain instructions for the purpose of generating a 3D point cloud of a scanned environment. Controller 38 provides operating signals to the light source 28, light receiver 36, panoramic camera 126, zenith motor 136 and azimuth motor 138. The controller 38 compares the operational parameters to predetermined variances and if the predetermined variance is exceeded, generates a signal that alerts an operator to a condition. The data received by the controller 38 is displayed on a user interface 40 coupled to controller 38. The user interface 40 includes one or more LEDs (light-emitting diodes) 82, an LCD (liquid-crystal diode) display, a CRT (cathode ray tube) display, a touch-screen display or the like. In some embodiments, a keypad is coupled to the user interface for providing data input to controller 38. In one embodiment, the user interface is arranged or executed on a mobile computing device that is coupled for communication, such as via a wired or wireless communications medium (e.g. Ethernet, serial, USB, Bluetooth™ or WiFi) for example, to the laser scanner 20.

The controller 38 is configured to connect to external computer networks such as a local area network (LAN) and the Internet. The LAN interconnects one or more remote computers, which are configured to communicate with controller 38 using a well-known computer communications protocol such as TCP/IP (Transmission Control Protocol/Internet(\hat{ }) Protocol), RS-232, ModBus, and the like. In some embodiments, additional systems 20 are provided that are connected to the LAN with the controllers 38 in each of these systems 20 being configured to send and receive data to and from remote computers and other systems 20. The LAN connects to the Internet. The connection between the LAN and the Internet allows controller 38 to communicate with one or more remote computers connected to the Internet.

The processors 122 are coupled to memory 124. The memory 124 includes random access memory (RAM) device 140, a non-volatile memory (NVM) device 142, and a read-only memory (ROM) device 144. In addition, the processors 122 are connected to one or more input/output (I/O) controllers 146 and a communications circuit 148. In an embodiment, the communications circuit 92 provides an interface that allows wireless or wired communication with one or more external devices or networks, such as the LAN discussed above.

Controller 38 includes operation control methods embodied in application code (e.g., program instructions executable by a processor to cause the processor to perform operations). These methods are embodied in computer instructions written to be executed by processors 122, typically in the form of software. The software is encoded in any language, including, but not limited to, assembly language, VHDL (Verilog Hardware Description Language), VHSIC HDL (Very High Speed IC Hardware Description Language), Fortran (formula translation), C, C++, C#, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing.

It should be appreciated that while embodiments herein describe the 3D coordinate measurement device as being a laser scanner, this is for example purposes and the claims should not be so limited. In other embodiments, the 3D coordinate measurement device is any device capable of measuring a plurality of points on surfaces (i.e., generates a point cloud), such as but not limited to a triangulation scanner, a structured light scanner, or a photogrammetry device for example.

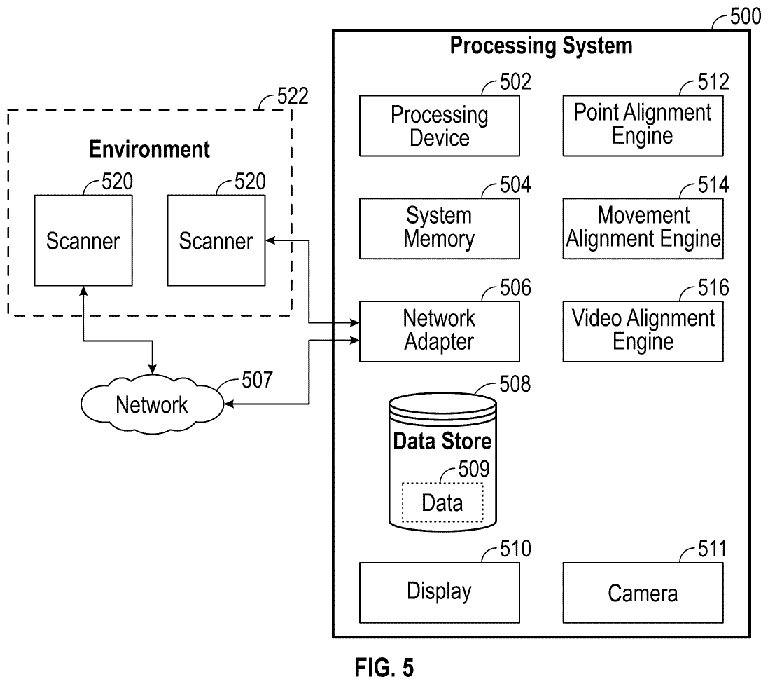

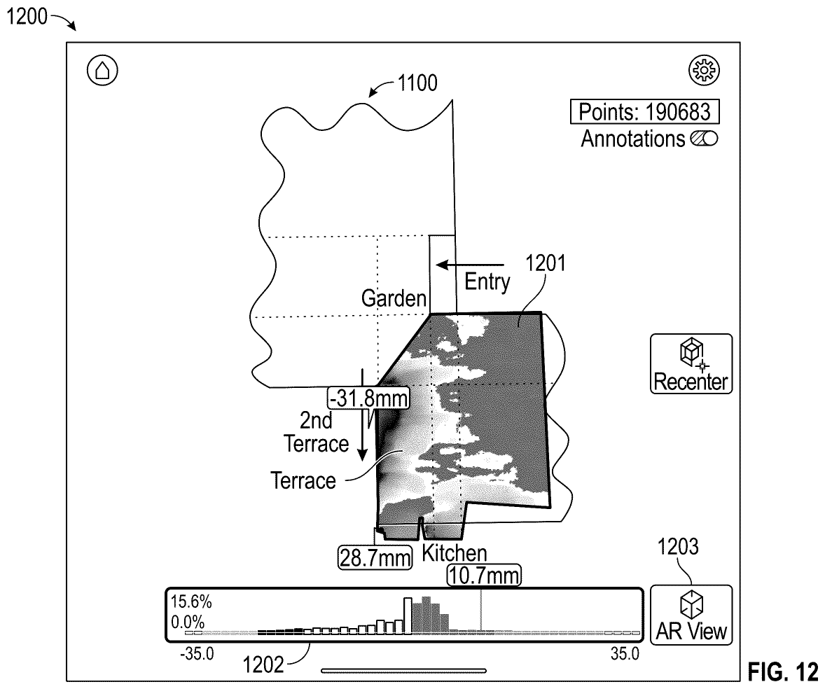

FIG. 5 is a schematic illustration of a processing system 500 for aligning and visualizing a point cloud according to one or more embodiments described herein. The processing system 500 includes a processing device 502 (e.g., one or more of the processing devices 1221 of FIG. 12), a system memory 504 (e.g., the RAM 1224 and/or the ROM 1222 of FIG. 12), a network adapter 506 (e.g., the network adapter 1226 of FIG. 12), a data store 508, a display 510, a camera 511, a point alignment engine 512, a movement alignment engine 514, and a video augmentation engine 516.

The various components, modules, engines, etc. described regarding FIG. 5 (e.g., the point alignment engine 512, the movement alignment engine 514, and the video augmentation engine 516.) are implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein are a combination of hardware and programming. The programming includes processor executable instructions stored on a tangible memory, and the hardware includes the processing device 502 for executing those instructions. Thus, the system memory 504 stores program instructions that when executed by the processing device 502 implement the engines described herein. Other engines are also utilized to include other features and functionality described in other examples herein.

The network adapter 506 enables the processing system 500 to transmit data to other sources and to receive data from other sources, such as scanners 520. For example, the processing system 500 receives data (e.g., a data set that includes a plurality of three-dimensional coordinates of an environment 522) from one or more of the scanners 520 directly, or via a network 507. The data from one or more of the scanners 520 is stored in the data store 508 of the processing system 500 as data 509, which is used to display a point cloud on the display 510. According to one or more embodiments described herein, the camera 511 captures images of the environment 522, which are presented on the display 510 as a video stream of the environment 522. According to one or more embodiments described herein, the processing system generates an augmented reality representation of the data 509 as a point cloud, which is overlaid onto a video stream captured by the camera 511 and displayed on the display 510.

The network 507 represents any one or a combination of different types of suitable communications networks such as, for example, cable networks, public networks (e.g., the Internet), private networks, wireless networks, cellular networks, or any other suitable private and/or public networks. Further, the network 507 has any suitable communication range associated therewith and includes, for example, global networks (e.g., the Internet), metropolitan area networks (MANs), wide area networks (WANs), local area networks (LANs), or personal area networks (PANs). In addition, the network 507 includes any type of medium over which network traffic is carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

One or more scanners 520 (e.g., a laser scanner) are arranged on, in, or around the environment 522 to scan the environment 522. It should be appreciated that while embodiments herein refer to a 3D coordinate measurement device as a laser scanner (e.g., the scanners 520), this is for example purposes and the claims should not be so limited. In other embodiments, other types of optical measurement devices such as, but not limited to, triangulation scanners and structured light scanners for example are viable substitutes for the one or more scanners 520.

According to one or more embodiments described herein, the scanners 520 include scanner processing systems such as a scanner controller, a housing, and a three-dimensional (3D) scanner. The 3D scanner is disposed within the housing and operably coupled to the scanner processing system. The 3D scanner includes a light source, a beam steering unit, a first angle measuring device, a second angle measuring device, and a light receiver. The beam steering unit cooperates with the light source and the light receiver to define a scan area. The light source and the light receiver are configured to cooperate with the scanner processing system to determine a first distance to a first object point based at least in part on a transmitting of a light by the light source and a receiving of a reflected light by the light receiver. The 3D scanner is further configured to cooperate with the scanner processing system to determine 3D coordinates of the first object point based at least in part on the first distance, a first angle of rotation, and a second angle of rotation.

The scanners 520 perform at least one scan to generate a data set that includes a plurality of three-dimensional coordinates of the environment 522. The data set is either transmitted, directly or indirectly (such as via a network) to a processing system, such as the processing system 500, which can store the data set as the data 509 in the data store 508. It should be appreciated that any number of scanners (e.g., one scanner, three scanners, four scanners, six scanners, eight scanners, etc.) are usable. According to one or more embodiments described herein, each of one or more scanners take multiple scans. For example, one of the scanners 520 captures first scan data at a first location and then is moved to a second location, where the one of the scanners 520 captures second scan data.

Using the data received from the scanners 520, the processing system 500 performs alignment and visualization of a point cloud using the data 509 using one or more of the point alignment engine 512, the movement alignment engine 514, and the video augmentation engine 516. For example, the point alignment engine 512 uses points in the point cloud and corresponding points in the environment to align the point cloud to the environment. As another example, the movement alignment engine 514 provides for moving the point cloud relative to the environment to align the point cloud to the environment. The video augmentation engine 516 uses the data 509 (e.g., data received from the scanners 520, for example) to generate an augmented reality representation of the data 509 as a point cloud, which can be overlaid onto a video stream captured by the camera 511. AR representations are further described herein, such as with reference to the figures described herein. The features and functionality of the point alignment engine 512, the movement alignment engine 514, and the video augmentation engine 516 are now described in more detail with reference to the following figures.

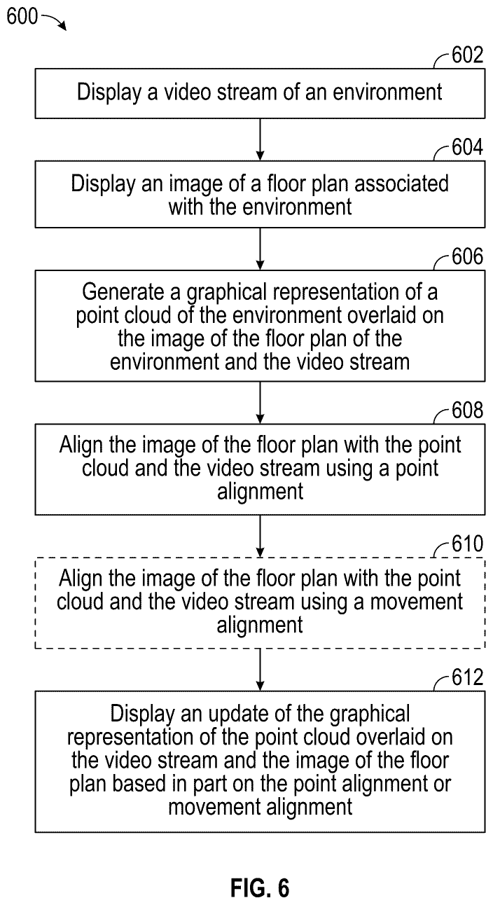

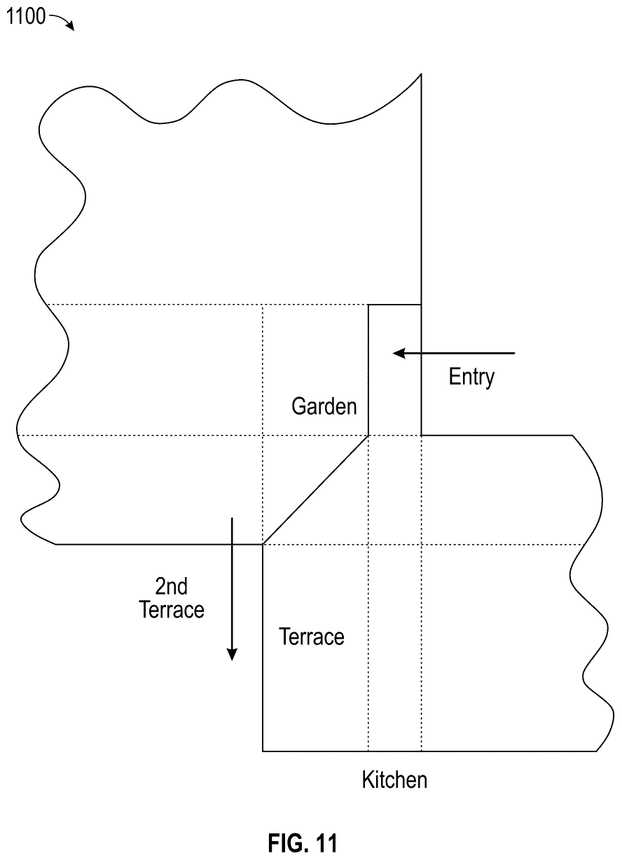

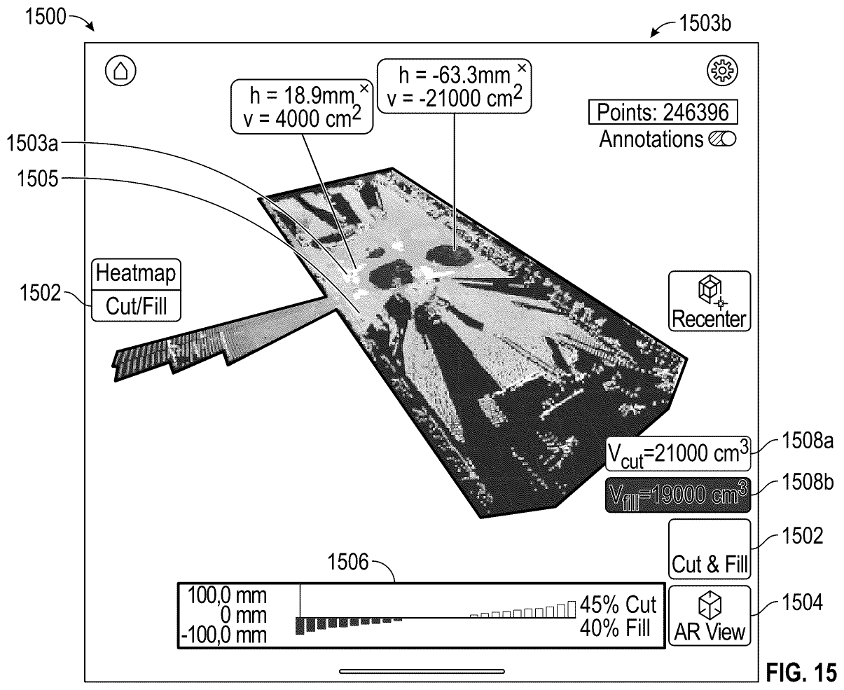

Turning now to FIG. 6, a flow diagram of a method 600 for aligning and visualizing a point cloud is provided according to one or more embodiments described herein. The method 600 is performed by any suitable system or device, such as the processing system 500 of FIG. 5 or the processing system 1500 of FIG. 15, alone or in combination. The method 600 is now described with respect to execution by the processing system 500 alone, for ease of illustration and without limitation, and with further reference to FIGS. 11-14.

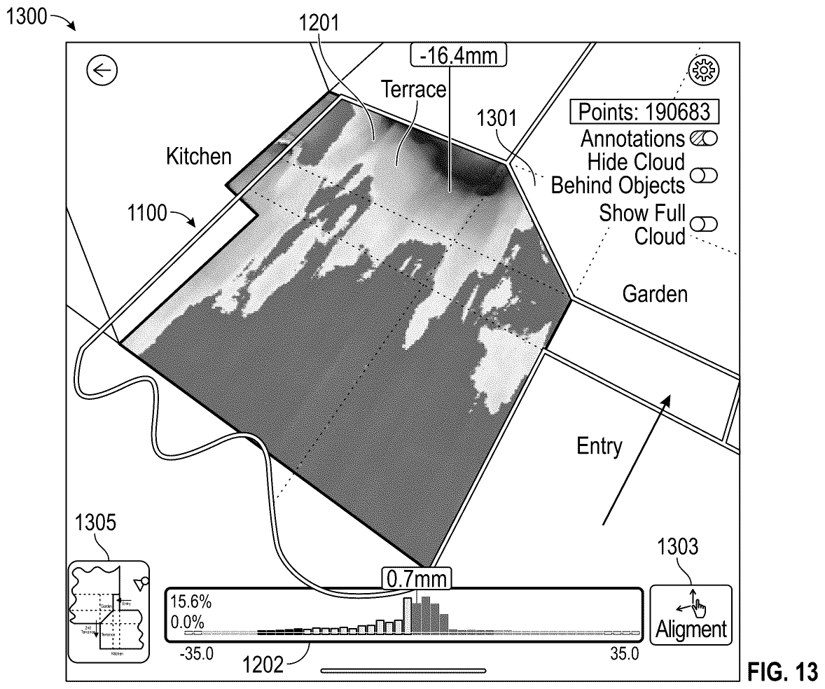

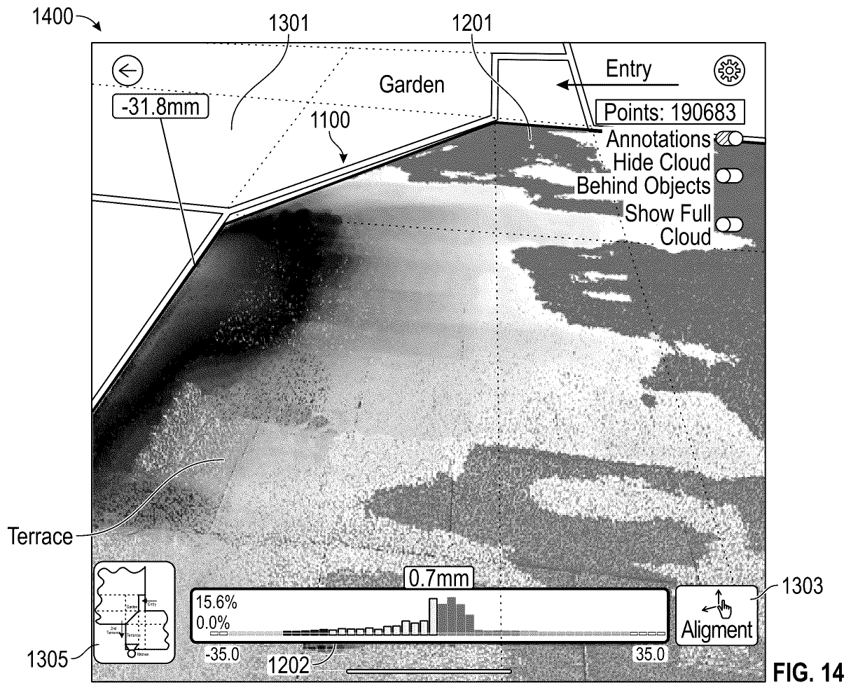

At block 602, the processing system 500 displays on the display 510 a video stream of an environment (e.g., the environment 522). For example, FIG. 13 shows a screenshot 1300 of a video stream of a first area of the environment and FIG. 14 shows a screenshot 1400 of the video stream of a second area of the environment 522.

At block 604, the processing system 500 displays an image of a floor plan associated with the environment 522. For example, FIG. 11 shows a rendering of a floor plan 1100. In some embodiments, the floor plan is stored in data store 508.

At block 606, the processing system 500, uses the video augmentation engine 516 to generate a graphical representation of a point cloud of an environment overlaid on the floor plan of the environment and the video stream of the environment. FIGS. 13 and 14 depict an example of a graphical representation of a point cloud 1201 according to one or more embodiments described herein. As shown on the screenshot 1300, a point cloud 1201 is overlaid on the floor plan 1100, and the point cloud 1201 and the floor plan 1100 are both overlaid on a video stream 1301 as a graphical representation. Similarly, the screen shot 1400, also shows the point cloud 1201 overlaid on the floor plan 1100, and the point cloud 1201 and the floor plan 1100 are both overlaid on the video stream 1301 from a different vantage point to that of the screenshot 1300. Both screenshots 1300 and 1400 include an alignment selection icon 1303.

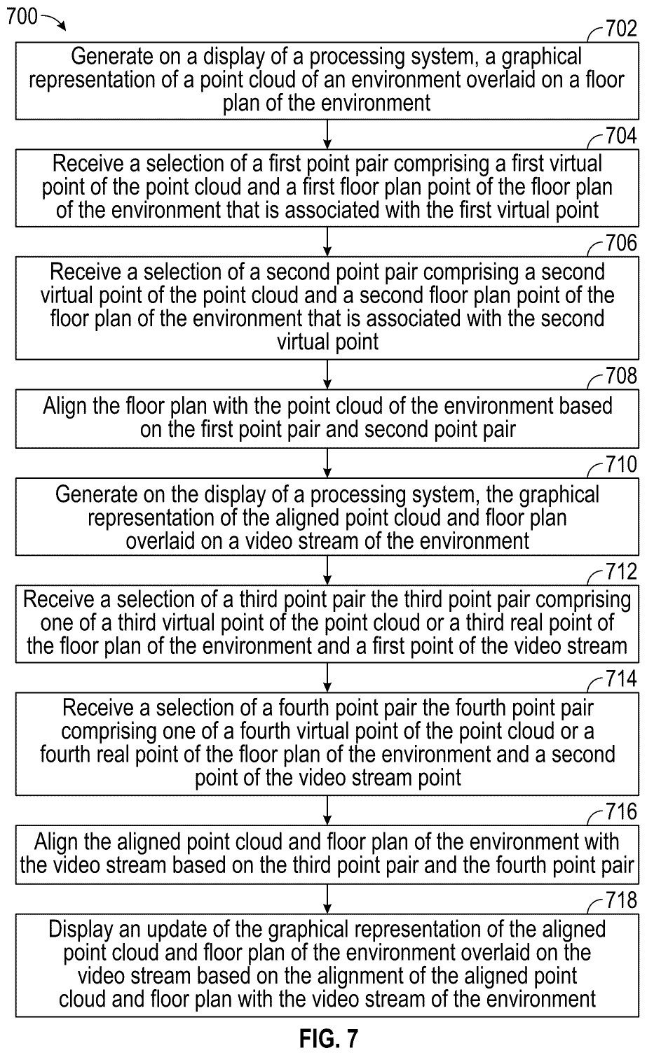

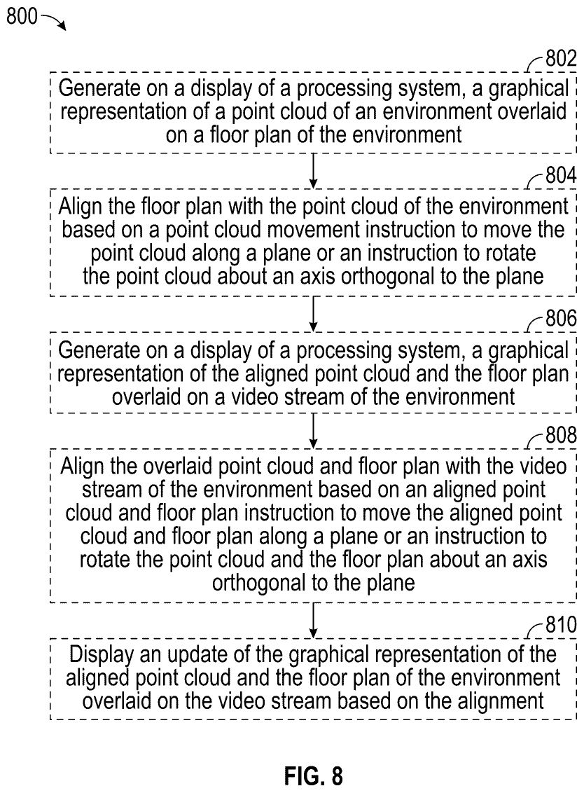

When the processing system 500 receives an input to activate the alignment selection icon 1303, the processing system 500 aligns the image of the floor plan 1100 with the point cloud 1201 and with the video stream 1301 using the point alignment engine 512 (e.g., the method 700 of FIG. 7) at block 608. After the processing system 500 performs the point alignment, the processor 500 aligns the image of the floor plan 1100 and the point cloud 1201 with the video stream 1301 using the movement alignment engine 514 (e.g., the method 800 of FIG. 8) at block 610. In some embodiments, the processing system 500 receives an input corresponding to the selection of an icon that causes the processing system 500 to perform a movement alignment. In other embodiments, the processing system 500 automatically performs the movement alignment as a result of the processing system being moved from one location to another. For example, screenshot 1300 is a first field of view captured by processing system 500 at a first time, and screenshot 1400 is a second field of view captured by processing system 500 at a second time that is different from the first time. As the processing system 500 moves from the first field of view to the second field of view, or vice versa, the processing system 500 performs the movement alignment automatically to ensure that the point cloud 1201 and floor plan 1100 remain aligned with the video stream 1301. In some embodiments, the movement alignment are performed by the processing system 500 that utilizes a movement alignment engine that is distinct and separate from the movement alignment engine 514. Accordingly, block 610 may or may not be executed by the processing system 500 using movement alignment engine 514 in various embodiments.

The processing system 500 then proceeds to block 612, where the graphical representation of the point cloud 1201 overlaid on the video stream 1301 and the image of the floor plan is updated based at least in part on the point alignment or the movement alignment.

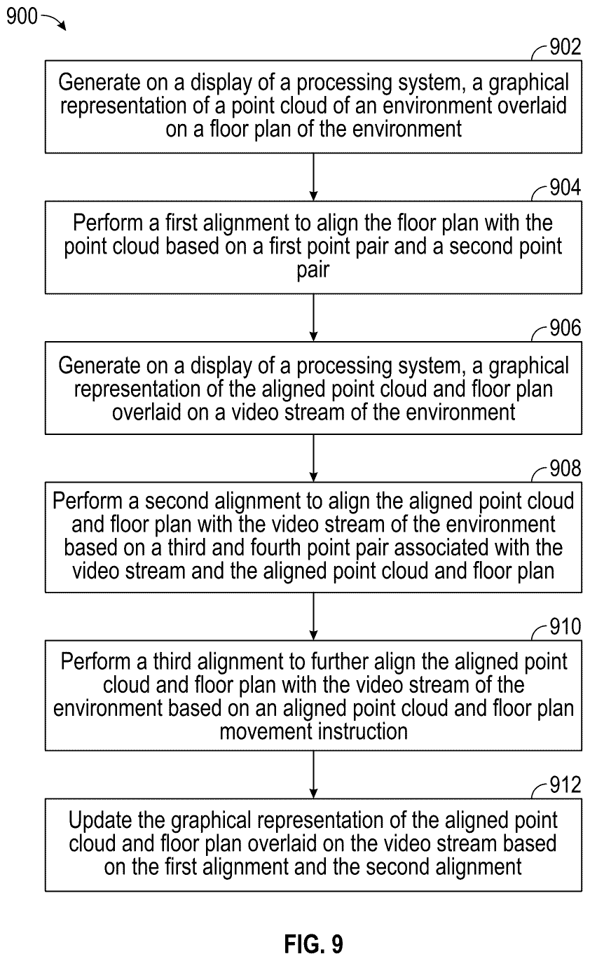

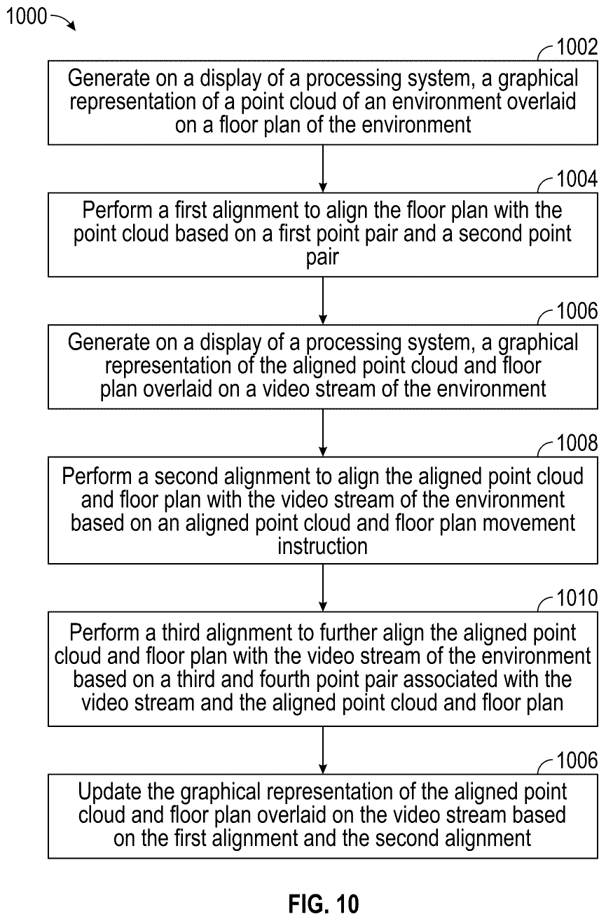

In some embodiments, the method 600 repeats such that point alignment and movement alignment are both performed or such that point alignment or movement alignment is performed multiple times. For example, FIGS. 9 and 10 depict methods 900 and 1000 respectively for performing both point alignment and movement alignment in different orders.

It should be understood that the process depicted in FIG. 6 represents an illustration, and that it is permissible to alter the process depicted in FIG. 6 to include new or other processes, or to remove, modify, or rearrange the existing processes as shown in FIG. 6 as readily contemplated without departing from the scope of the present disclosure.

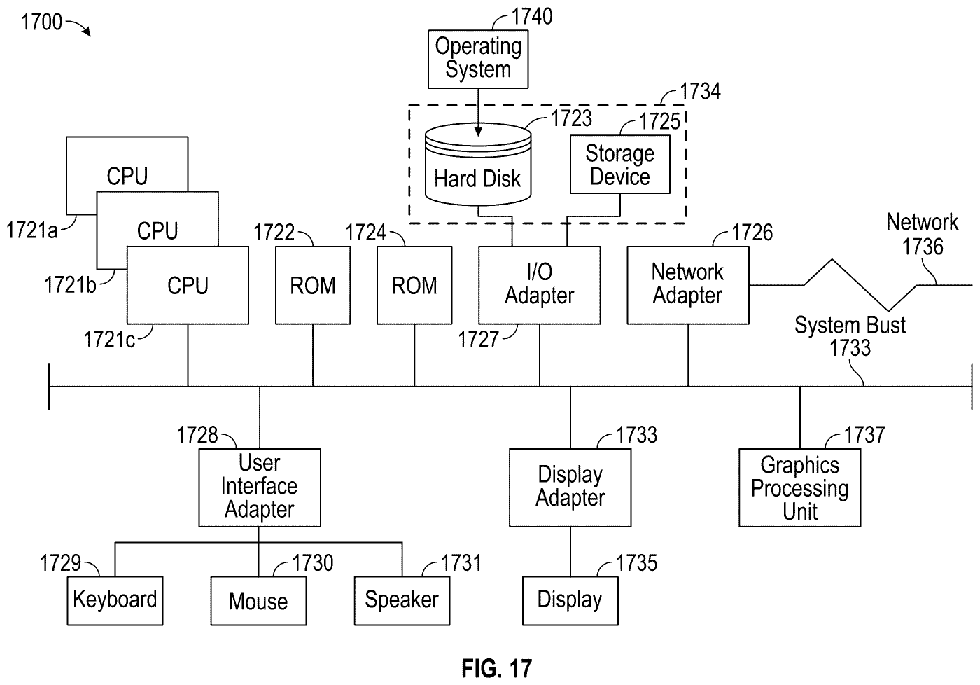

FIG. 7 is a flow diagram of a method for aligning and visualizing a point cloud and floor plan of an environment according to one or more embodiments. In some embodiments, the method 700 is performed by any suitable system or device, such as the processing system 500 of FIG. 5 or the processing system 1700 of FIG. 17. The method 700 is now described with respect to processing system 500 alone for ease of illustration and without limitation, and with further reference to FIGS. 12-14.

At block 702, the processing system 500, such as using the video augmentation engine 516, generates a graphical representation of a point cloud of an environment overlaid on a floor plan of the environment 522. FIG. 12 depicts an example of a graphical representation of a point cloud 1201 overlaid onto a floor plan 1100 according to one or more embodiments described herein.

With continued reference to FIG. 7, at block 704, the processing system 500 receives a selection of a first point pair from a user. The first point pair includes a first virtual point of the point cloud and a first floor plan point of the floor plan of the environment 522 that is associated with the first virtual point. For example, a user selects (e.g., using an input device of the processing system 500, such as the display 510 that is configured as a touch screen display) a virtual point of the point cloud and similarly selects a corresponding floor plan point from the floor plan. In some embodiments, the floor plan point is a corner of a room on the floor plan, a point along an edge of two planes meeting (e.g., a surface of a box meeting a surface of a floor upon which the box is resting), or the like. In some embodiments, the selected points are features easily identifiable on the floor plan, such as an edge where a wall meets a floor or another wall or other features having ease of identification.

With continued reference to FIG. 7, at block 706, the processing system 500 receives a selection of a second point pair. The second point pair comprises a second virtual point of the point cloud and a second floor plan point of the floor plan of the environment 522, where the second floor plan point corresponds to the second virtual point.

With continued reference to FIG. 7, at block 708, the processing system aligns the floor plan associated with the environment 522 with the point cloud based at least in part on the first point pair and the second point pair. According to one or more embodiments described herein, the alignment can be based on distances between points of the point pairs. For example, the processing system 500 determines a first distance (e.g., a Euclidean distance) between the first virtual point and the first floor plan point and determines a second distance between the second virtual point and the second floor plan point. The point cloud is then “moved” or adjusted relative to floor plan associated with the environment 522 to reduce or minimize one or both of the first distance or the second distance. According to one or more embodiments described herein, the point cloud represents points on a floor, so movement or rotation of the point cloud occurs on a plane defined by the floor. In such examples, only two points are required for alignment because the movement is planar. In some examples, the alignment is based on an average of the first distance and a second distance, such that the point cloud is aligned to reduce or minimize the average distance. According to one or more embodiments described herein, more than two point pairs are implemented, and the alignment is based on distances for each of the point pairs.

At block 710, the processing system 500 generates on the display 510 the graphical representation of the aligned point cloud 1201 and floor plan 1100 overlaid on the video stream of the environment 522. At block 712, the processing system 500 receives a selection of a third point pair. The third point pair comprises one of a third virtual point of the point cloud or a third real point of the floor plan 1100 of the environment 522, and a first point of the video stream 1301. At block 714, the processing system 500 receives a selection of a fourth point pair. The fourth point pair comprises one of a fourth virtual point of the point cloud 1201 or a fourth real point of the floor plan 1100 of the environment 522, and a second point of the video stream 1301. At block 716, the processing system 500 aligns the aligned point cloud 1201 and floor plan 1100 of the environment 522. At block 718 the processing system 500 causes the display 510 to generate an update of the graphical representation of the aligned point cloud 1201 and floor plan 1100 of the environment overlaid on the video stream 1301 based on the alignment of the aligned point cloud 1201 and floor plan 1100 with the video stream 1301 of the environment 522.

In some embodiments, additional processes are also included. According to one or more embodiments described herein, the movement of the processing system 500 is tracked (e.g., using SLAM as described herein) as it moves relative throughout the environment 522. The graphical representation of the point cloud 1201 is updated in real-time (or near-real-time) based on the movement of the processing system 500 while maintaining alignment between the point cloud 1201 and the video stream 1301 of the environment 522. This is shown in the example of FIGS. 13 and 14, where the point cloud 1201 remains aligned with the video stream 1301 as the field of view changes from screenshot 1300 to screenshot 1400 of the environment 522 even though the processing system 500 has moved relative to the environment 522.

It should be understood that the process depicted in FIG. 7 represents an illustration, and that it is permissible to alter the process depicted in FIG. 7 to include new or other processes, or to remove, modify, or rearrange the existing processes as shown in FIG. 7 without departing from the scope of the present disclosure.

FIG. 8 is a flow diagram of a method for aligning and visualizing a point cloud and floor plan of an environment according to one or more embodiments described herein. In some embodiments, the method 800 is performed by any suitable system or device, such as the processing system 500 of FIG. 5 or the processing system 1700 of FIG. 17.

At block 802, the processing system 500, such as using the video augmentation engine 516, generates a graphical representation of a point cloud (e.g., point cloud 1201) of an environment 522 overlaid on a floor plan (e.g., floor plan 1100) of the environment 522.

At block 804, the processing system 500, using the movement alignment engine 514, aligns the floor plan 1101 to the point cloud 1201 of the environment 522 based at least in part on a point cloud movement instruction. The point cloud movement instruction is inclusive of an instruction to move the point cloud 1201 along a plane or an instruction to rotate the point cloud 1201 about an axis orthogonal to the plane in various embodiments. For example, with reference to FIG. 12, as shown on the screenshot 1200, a point cloud 1201 is overlaid on the floor plan 1100. In some embodiments, the processing system 500 receives an input corresponding to a movement alignment selection that defines a point for performing the movement alignment. The point defines a point of movement for moving the point cloud 1201 relative to the floor plan 1100. The user manipulates the point cloud 1201 relative to the floor plan 1100 by providing a movement instruction, via a device, such as a touchscreen, mouse, stylus, etc. In some cases, the processing system 500 processes gestures performed by a user, such as a two-finger gesture on the display to move the point cloud 1201 along a plane, a one-finger gesture to rotate the point cloud 1201 about the point on the plane. In the case of moving the point cloud 1201 along a plane, the point defines a plane, such as a plane substantially horizontal to a surface of the floor plan 1100 associated with the environment 522 (e.g., a portion of a floor, or some other suitable surface). The processing system 500 moves the point cloud 1201 along the plane in response to a corresponding point selection gesture performed by the user. The processing system 500 also rotates the point cloud 1201 about the point in response to a corresponding rotation gesture performed by the user. Thus, the point defines a plane and an axis orthogonal to the plane for performing movement alignment. According to one or more embodiments described herein, the processing system 500 moves the location of the point such that the center of rotation is moved in response to a user gesture.

At block 806, processing system 500 causes the display 510 to generate a graphical representation of the aligned point cloud 1201 and floor plan 1100 overlaid on the video stream 1301 based at least in part on the alignment.

At block 808, the processing system 500, aligns the overlaid point cloud 1201 and the floor plan 1100 with the video stream 1301 of the environment 522 based on an aligned point cloud and floor plan instruction to move the aligned point cloud 1201 and floor plan 1100 along a plane or an instruction to rotate the point cloud 1201 and the floor plan 110 about an axis orthogonal to the plane. At block 810, the processing system 500, causes the display 510 to generate an updated graphical representation of the aligned point cloud 1201 and the floor plan 1100 of the environment 522 overlaid on the video stream 1301 based on the alignment.

It should be understood that the process depicted in FIG. 8 represents an illustration, and that it is permissible to alter the process depicted in FIG. 8 to include new or other processes, or to remove, modify, or rearrange the existing processes as shown in FIG. 8 without departing from the scope of the present disclosure.

FIG. 9 is a flow diagram of a method for aligning and visualizing a point cloud and floor plan of an environment according to one or more embodiments described herein. The method 900 is performed by any suitable system or device, such as the processing system 500 of FIG. 5 or the processing system 1700 of FIG. 17.

At block 902, the processing system 500, using the video augmentation engine 516, generates, on the display 510, a graphical representation of a point cloud of an environment overlaid on a floor plan of the environment. At block 904, the processing system 500, using the point alignment engine 512, performs a first alignment to align the floor plan 1100 to the point cloud 1201 associated with the environment 522 based at least in part on a first point pair and the second point pair. At block 906, the processing system 500, causes the display 510 to generate a display of a graphical representation of the aligned point cloud 1201 and floor plan 1100 overlaid on a video stream 1301 of the environment 522. At block 908, the processing system, using the point alignment engine 514, performs a second alignment to align the aligned point cloud 1201 and floor plan 1100 with the video stream 1301 of the environment 522 based at least in part on a point cloud movement instruction. The aligned point cloud 1201 and floor plan 1101 are aligned with the video stream 1301 in response to a user selecting a third and fourth point pair associated with the video stream and the aligned point cloud and floor plan.

At block 910, the processing system 500, performs a third alignment using the movement alignment engine 516 to further align the aligned point cloud and floor plan with the video stream of the environment based on an aligned point cloud and floor plan movement instruction. At block 912, the processing system 500, using the video augmentation engine 516, updates the graphical representation of the aligned point cloud 1201 and floor plan 1100 overlaid on the video stream 1301 based at least in part on the first alignment and the second alignment.

According to one or more embodiments described herein, the point cloud movement instruction is an instruction to move the point cloud 1201 along a plane or an instruction to rotate the point cloud 1201 about an axis orthogonal to the plane. According to one or more embodiments described herein, the first point pair includes a first virtual point of the point cloud 1201 and a first floor plan point of the environment, the first floor plan point corresponding to the first virtual point. According to one or more embodiments described herein, the second point pair includes a second virtual point of the point cloud 1201 and a second floor plan point of the floor plan, the second floor plan point corresponding to the second virtual point. The third point pair includes a third virtual point of the point cloud 1201 and a first real point of the video stream 1301 of the environment, the first real point corresponding to the third virtual point. According to one or more embodiments described herein, the fourth point pair includes a fourth virtual point of the point cloud 1201 and a second real point of the video stream 1301, the second real point corresponding to the fourth virtual point.

It should be understood that the process depicted in FIG. 9 represents an illustration, and that it is permissible to alter the process depicted in FIG. 9 to include new or other processes, or to remove, modify, or rearrange the existing processes as shown in FIG. 9 without departing from the scope of the present disclosure.

FIG. 10 is a flow diagram of a method for aligning and visualizing a point cloud and floor plan of an environment according to one or more embodiments described herein. The method 1000 is performed by any suitable system or device, such as, but not limited to, the processing system 500 of FIG. 5 or the processing system 1700 of FIG. 17, alone or in combination.

At block 1002, the processing system 500, using the video augmentation engine 516, generates on the display 510, a graphical representation of a point cloud of an environment overlaid on a floor plan of the environment. At block 1004, the processing system 500, using the point alignment engine 512, performs a first alignment to align the floor plan 1100 associated with the environment 522 to the point cloud 1201 based at least in part on a first point pair and a second point pair. At block 1006, the processing system 500, causes the display 510 to generate a display of a graphical representation of the aligned point cloud 1201 and floor plan 1100 overlaid on a video stream 1301 of the environment 522. At block 1008, the processing system, using the movement alignment engine 516, performs a second alignment to align the aligned point cloud and floor plan with the video stream of the environment based on an aligned point cloud and floor plan movement instruction. The aligned point cloud 1201 and floor plan 110 can be aligned with the video stream 1301 in response to a user selecting a third and fourth point pair associated with the video stream and the aligned point cloud and floor plan.

At block 1010, the processing system 500, can perform a third alignment to further align the aligned point cloud and floor plan with the video stream of the environment based on the third and fourth point pair associated with the video stream and the aligned point cloud and floor plan. At block 1012, the processing system 500, using the video augmentation engine 516, updates the graphical representation of the aligned point cloud 1201 and floor plan 1100 overlaid on the video stream 1301 based at least in part on the first alignment and the second alignment.

According to one or more embodiments described herein, the point cloud movement instruction is an instruction to move the point cloud 1201 along a plane or an instruction to rotate the point cloud 1201 about an axis orthogonal to the plane. According to one or more embodiments described herein, the first point pair includes a first virtual point of the point cloud 1201 and a first floor plan point of the environment 522, the first floor plan point corresponding to the first virtual point. According to one or more embodiments described herein, the second point pair includes a second virtual point of the point cloud 1201 and a second floor plan point of the environment 522, the second floor plan point corresponding to the second virtual point.

It should be understood that the process depicted in FIG. 9 represents an illustration, and that it is permissible to alter the process depicted in FIG. 9 to include new or other processes, or to remove, modify, or rearrange the existing processes as shown in FIG. 9 without departing from the scope of the present disclosure.

FIG. 11 depicts a floor plan 1100 associated with environment 522 according to one or more embodiments described herein. In some embodiments, the floor plan 1000 has a white or transparent background with black or white solid lines defining different areas of the floor plan. In some embodiments, black or white dashed lines are substituted for black or white solid lines. In other embodiments, the lines and background are other colors other than black and white, that are of sufficient contrast to each other as to allow a user to easily see the lines on the background (e.g. blue lines on a yellow or gray background). Accordingly, while embodiments herein refer to a particular color line or background, this is for example purposes and the claims should not be so limited.

FIG. 12 depicts a screenshot 1200 of a point cloud 1201 overlaid on the floor plan 1100 according to one or more embodiments described herein. In some embodiments, the point cloud 1201 comprises various colors each of which can represent a distance below or above grade in a certain field of view of video stream of the environment 522. Scale 1202 includes bands of distances each of which are associated with a different color. For instance, screenshot 1200 depicts a first area of the point cloud 1201 that is −31.8 millimeters below grade and a second area of the point cloud 1201 that is below grade by an amount of 28.7 millimeters. Screenshot 1200 also includes an AR View icon 1203 that can be selected by a user which in turn causes the point cloud 1201 that is overlaid on the floor plan 110 and aligned with the floor plan 1100 to be overlaid on a video stream (e.g., video stream 1301) in an augmented reality or virtual environment.

FIG. 13 depicts a screenshot 1300 of the point cloud 1201 overlaid on the floor plan 100 and virtual environment, or video stream 1301, from a first field of view according to one or more embodiments described herein. The screenshot also includes an alignment icon 1303 activated by the user in response to the user touching the alignment icon 1303. The activation of the alignment icon 1303 causes the processing system 500 to display a point alignment feature or a movement alignment feature. The screenshot 1300 also includes the floor plan 1100 in the lower left hand corner. The screenshot 1300 also includes the scale 1202.

FIG. 14 depicts a screenshot 1400 of the point cloud 1201 overlaid on the floor plan 100 and virtual environment, or video stream 1301, from a second field of view according to one or more embodiments described herein. The screenshot also includes the alignment icon 1303 activated by the user in response to the user touching the alignment icon 1303. The activation of the alignment icon 1303 causes the processing system 500 to display a point alignment feature or a movement alignment feature. The screenshot 1400 also includes the floor plan 1100 in the lower left hand corner. The screenshot 1400 also includes the scale 1202.

In further embodiments, a point cloud is generated that visualizes the difference between the actual height of a floor and the height that the floor should be. In some embodiments, the height that the floor should be is determined by the user as the processing system 500 is taking a scan of the environment associated with the floor plan. In some embodiments the height that the floor plan should be is downloaded to the processing system 500 whenever the processing system is within a certain geographic area of the actual floor. In some embodiments, the user selects an acceptable tolerance of deviation from the height that the floor should be. After the height that the floor should be is selected, and the acceptable tolerance for a deviation from the height that the floor should be have been selected and inputted to the processing system 500, the processing system 500 generates an image in accordance with screenshot 1500 in FIG. 15 in various embodiments.

FIG. 15 depicts one example of a screenshot 1500 having a point cloud, depicted in various gray shades, overlaid on a floor plan 1505, in which the point cloud visualizes parts of a floor that have a height that is outside of a floor flatness tolerance according to one or more embodiments described herein. In various embodiments, the screenshot 1500 is instead in color with points in various colors, such as red and blue, in place of grayscale. For example, in FIG. 15, a portion of the floor plan 1505 that has a height that is greater than an acceptable floor flatness tolerance corresponds to point cloud area 1503a and a portion of the floor plan 1505 that has a height that is less than an acceptable floor flatness tolerance corresponds to a point cloud area 1503b.

Scale 1506 represents a point cloud measurement of the height of the floor being above or below the height that the floor should be. For instance, the left side of the scale 1506 includes an exemplary range between −100 millimeters and 100 millimeters. This range indicates how many millimeters below or above grade that the actual floor is relative to the height that the floor should be. The scale 1506 also includes a percentage of volume of material (concrete) that needs to be removed or added to the floor as indicated by the range 45% cut to 40% fill. Shaded bars indicate the actual height of the floor that is above or below the height that the floor should be. In an embodiment, red bars indicate the actual height of the floor that is above the height that the floor should be and blue bars indicate the actual height of the floor that is below specifications. Icons 1508a and 1508b indicate the total amount of material, by volume in cubic centimeters, that needs to be removed from certain areas of the entire floor, and the total amount of material, by volume in cubic centimeters, that needs to be added to certain areas of the floor based on the point cloud measurement data in various embodiments.

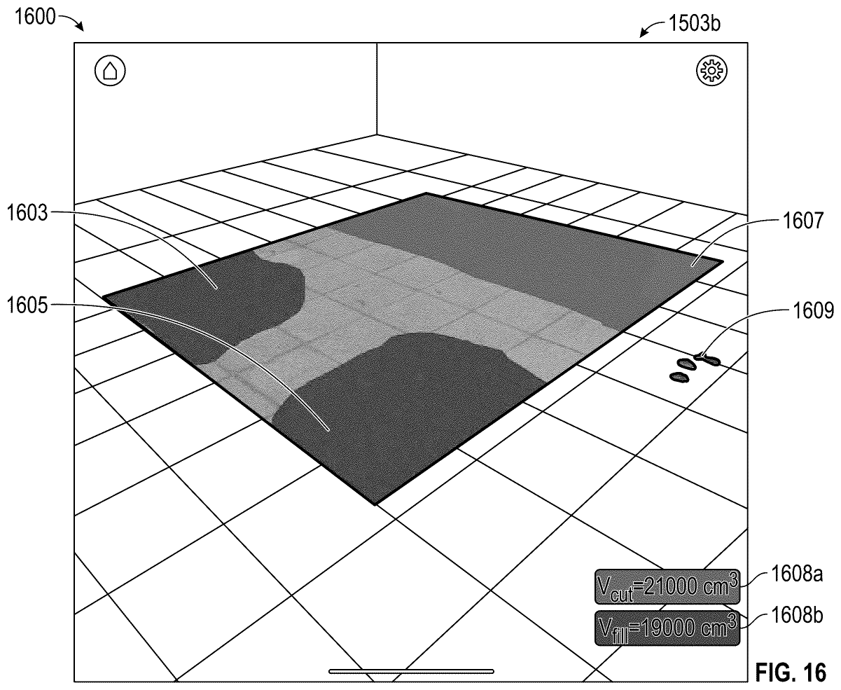

The screenshot 1500 also shows an icon 1502 that enables a user to toggle between a heatmap view and cut and fill view. As shown in the screenshot 1500, the heatmap view is greyed out indicating that it is disabled, and the cut and fill view is not greyed out indicating that the cut and fill view is what is being displayed on the display 510. Cut & Fill 1502 is an icon that is activated in response to the user adding the point cloud data to the floor plan or removing the point cloud data from the floor plan in various embodiments. The processing system 500 will also toggle between the floor plan shown in screen shot 1500 in FIG. 15 and an augmented reality view much like the one shown in FIG. 16 by activating the icon AR 1504, in response to a user input to toggle between the floor plan shown in FIG. 15 and the floor plan show in FIG. 16.

FIG. 16 depicts a point cloud overlaid on a video stream that visualizes parts of a floor that have a height that is outside of a floor flatness tolerance according to one or more embodiments described herein. Screenshot 1600 shows point cloud areas 1603, 1605, and 1607 overlaid onto a video stream corresponding to an augmented reality environment 1609. Overlaying the point cloud areas 1603, 1605, and 1607 on top of the video stream corresponding to the augmented reality environment 1609, enables a user to see where additional material needs to be added to the actual floor, and where material needs to be removed from the actual floor. Icons 1608a and 1608b indicate the total amount of material, by volume in cubic centimeters, that needs to be removed from certain areas of the entire floor, and the total amount of material, by volume in cubic centimeters, that needs to be added to certain areas of the floor based on the point cloud measurement data.

It is understood that one or more embodiments described herein is capable of being implemented in conjunction with any other type of computing environment now known or later developed. For example, FIG. 17 depicts a block diagram of a processing system 1700 for implementing the techniques described herein. In accordance with one or more embodiments described herein, the processing system 1700 is an example of a cloud computing node of a cloud computing environment. In examples, processing system 1700 has one or more central processing units (“processors” or “processing resources” or “processing devices”) 1721a, 1721b, 1721c, etc. (collectively or generically referred to as processor(s) 1721 and/or as processing device(s)). In aspects of the present disclosure, each processor 1721 includes a reduced instruction set computer (RISC) microprocessor. Processors 1721 are coupled to system memory (e.g., random access memory (RAM) 1724) and various other components via a system bus 1733. Read only memory (ROM) 1722 is coupled to system bus 1733 and includes a basic input/output system (BIOS), which controls certain basic functions of processing system 1700.

Further depicted are an input/output (I/O) adapter 1727 and a network adapter 1726 coupled to system bus 1733. In some embodiments, I/O adapter 1727 is a small computer system interface (SCSI) adapter that communicates with a hard disk 1723 and/or a storage device 1725 or any other similar component. I/O adapter 1727, hard disk 1723, and storage device 1725 are collectively referred to herein as mass storage 1734. Operating system 1740 is stored in mass storage 1734, and is executed on processing system 1700. The network adapter 1726 interconnects system bus 1733 with an outside network 1736 enabling processing system 1700 to communicate with other such systems.

A display (e.g., a display monitor) 1735 is connected to system bus 1733 by display adapter 1732, which includes a graphics adapter to improve the performance of graphics intensive applications and a video controller. In one aspect of the present disclosure, adapters 1726, 1727, and/or 1732 are connected to one or more I/O busses that are connected to system bus 1733 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 1733 via user interface adapter 1728 and display adapter 1732. A keyboard 1729, mouse 1730, and speaker 1731 are interconnected to system bus 1733 via user interface adapter 1728, which includes, for example, a Super I/O chip integrating multiple device adapters into a single integrated circuit in various embodiments.

In some aspects of the present disclosure, processing system 1700 includes a graphics processing unit 1737. Graphics processing unit 1737 is a specialized electronic circuit designed to manipulate and alter memory to accelerate the creation of images in a frame buffer intended for output to a display. In general, graphics processing unit 1737 is very efficient at manipulating computer graphics and image processing, and has a highly parallel structure that makes it more effective than general-purpose CPUs for algorithms where processing of large blocks of data is done in parallel.

Thus, as configured herein, processing system 1700 includes processing capability in the form of processors 1721, storage capability including system memory (e.g., RAM 1724), and mass storage 1734, input means such as keyboard 1729 and mouse 1730, and output capability including speaker 1731 and display 1735. In some aspects of the present disclosure, a portion of system memory (e.g., RAM 1724) and mass storage 1734 collectively store the operating system 1740 to coordinate the functions of the various components shown in processing system 1700.

It will be appreciated that one or more embodiments described herein are embodied as a system, method, or computer program product and take the form of a hardware embodiment, a software embodiment (including firmware, resident software, micro-code, etc.), or a combination thereof. Furthermore, one or more embodiments described herein take the form of a computer program product embodied in one or more computer readable medium(s) having computer readable program code embodied thereon.

The term “about” is intended to include the degree of error associated with measurement of the particular quantity based upon the equipment available at the time of filing of this application. For example, “about” is inclusive of a range of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

The methods disclosed herein for point cloud alignment with a floor plan or a video stream of an environment, use a heatmap as a graphical representation of the point cloud. In some embodiments, the graphical representation is a cut-and-fill representation. The methods disclosed herein for point cloud alignment with a floor plan or a video stream of an environment comprise receiving a first input associated with the point alignment, wherein the first input is a first point pair comprising a first virtual point associated with the point cloud and a first floor plan point associated with the floor plan. In some embodiments, the point pair is a corner of a room on the floor plan, a point on an edge where two planes meet. Further still in other embodiments, there is a first plane of the two planes that is a plane associated with a floor corresponding to the floor plan, and a second plane of the two planes that is a plane associated with a wall in the environment.

The methods disclosed herein for point cloud alignment with a floor plan or a video stream of an environment further comprise receiving a second input associated with the point alignment. In some embodiments, the second input is a second point pair comprising a second virtual point associated with the point cloud and a second floor plan point associated with the floor plan. In some embodiments, the method further comprises aligning the graphical representation of the point cloud with the image of the floor plan based at least in part on a distance between the first virtual point and the first floor plan point. The further comprises aligning the graphical representation of the point cloud with the image of the floor plan based at least in part on a distance between the second virtual point and the second floor plan point. In some embodiments, the method further comprises aligning the graphical representation of the point cloud with the image of the floor plan based at least in part on a first distance between the first virtual point and the first floor plan point, and a second distance between the second virtual point and the second floor plan point.

The methods disclosed herein for point cloud alignment with a floor plan or a video stream of an environment further comprise receiving a first input associated with the point alignment, wherein the first input is associated with the first point pair and receiving a second input associated with the point alignment, wherein the second input is associated with the second point pair. In some embodiments, the alignment is based at least in part on an average of the first distance and the second distance.

The methods disclosed herein for point cloud alignment with a floor plan or a video stream of an environment further comprise aligning the aligned point cloud and image of the floor plan with the video stream based at least in part on a third point pair. In certain embodiments, the third point pair comprises one of a third virtual point associated with the point cloud or a third floor plan point associated with the image of the floor plan. and a first point of the video stream. methods disclosed herein for point cloud alignment with a floor plan or a video stream of an environment further comprise moving the aligned point cloud and image of the floor plan relative to the video stream such that the distance between the third virtual point and the first point of the video stream is minimized.

The methods disclosed herein for point cloud alignment with a floor plan or a video stream of an environment further comprise aligning the aligned point cloud and image of the floor plan with the video stream based at least in part on a fourth point pair. The fourth point pair comprises one of a fourth virtual point associated with the point cloud or a fourth floor plan point associated with the image of the floor plan, and a second point of the video stream, and moving the aligned point cloud and image of the floor plan relative to the video stream such that the distance between the fourth virtual point and the second point of the video stream is minimized.

In some embodiments, the third point pair is the first point pair or the second point pair, and the fourth point pair is the first point pair or the second point pair. In some embodiments, the alignment is based at least in part on an average of the distance between the third virtual point and the first point of the video stream is minimized, and the distance between the fourth virtual point and the second point of the video stream is minimized.

What is claimed is:

1. A method for point cloud alignment with a representation of an environment, the method comprising:
overlaying a graphical representation of a point cloud onto an image of a floor plan and a video stream;
aligning the graphical representation of the point cloud with the image using a point alignment; and
displaying an update of the graphical representation based at least in part on at least one of a further point alignment and a movement alignment.

2. The method of claim 1, wherein the graphical representation is a heatmap representation.

3. The method of claim 1, wherein the graphical representation is a cut-and-fill representation.

4. The method of claim 1, the method further comprising receiving a first input associated with the point alignment, wherein the first input is a first point pair comprising a first virtual point associated with the point cloud and a first floor plan point associated with the floor plan.

5. The method of claim 4, wherein the point pair is at least one of a corner of a room on the floor plan, a point on an edge where two planes meet.

6. The method of claim 5, wherein a first plane of the two planes is a plane associated with a floor corresponding to the floor plan, and a second plane of the two planes is a plane associated with a wall in the environment.

7. The method of claim 4, the method further comprising receiving a second input associated with the point alignment, wherein the second input is a second point pair comprising a second virtual point associated with the point cloud and a second floor plan point associated with the floor plan.

8. The method of claim 4, the method further comprising aligning the graphical representation of the point cloud with the image of the floor plan based at least in part on a distance between the first virtual point and the first floor plan point.

9. The method of claim 4, the method further comprising aligning the graphical representation of the point cloud with the image of the floor plan based at least in part on a distance between the second virtual point and the second floor plan point.

10. The method of claim 9, the method further comprising aligning the graphical representation of the point cloud with the image of the floor plan based at least in part on a first distance between the first virtual point and the first floor plan point, and a second distance between the second virtual point and the second floor plan point.

11. A method for point cloud alignment with a floor plan or a video stream of an environment, the method comprising:
overlaying a graphical representation of a point cloud onto an image of the floor plan and the video stream;
aligning the graphical representation of the point cloud with the image of the floor plan or the video stream based at least in part on:
a first point pair comprising a first virtual point associated with the point cloud and a first floor plan point associated with the image of the floor plan,
a second point pair comprising a second virtual point associated with the point cloud and a second floor plan point associated with the image of the floor plan,
a first distance between the first virtual point and the first floor plan point, and a second distance between the second virtual point and the second floor plan point, and
moving the point cloud relative to the image of the floor plan such that the first distance is minimized or such that the second distance is minimized; and
displaying an update of the graphical representation based at least in part on a further point alignment or a movement alignment.

12. The method of claim 11, wherein the graphical representation is a heatmap representation.

13. The method of claim 11, wherein the graphical representation is a cut-and-fill representation.

14. The method of claim 11, the method further comprising receiving a first input associated with the point alignment, wherein the first input is associated with the first point pair and receiving a second input associated with the point alignment, wherein the second input is associated with the second point pair.

15. The method of claim 11, wherein the alignment is based at least in part on an average of the first distance and the second distance.

16. The method of claim 11, the method further comprising aligning the aligned point cloud and image of the floor plan with the video stream based at least in part on:
a third point pair comprising:
one of a third virtual point associated with the point cloud or a third floor plan point associated with the image of the floor plan, and
a first point of the video stream, and
moving the aligned point cloud and image of the floor plan relative to the video stream such that the distance between the third virtual point and the first point of the video stream is minimized.

17. The method of claim 16, the method further comprising aligning the aligned point cloud and image of the floor plan with the video stream based at least in part on:
a fourth point pair comprising:
one of a fourth virtual point associated with the point cloud or a fourth floor plan point associated with the image of the floor plan, and
a second point of the video stream, and
moving the aligned point cloud and image of the floor plan relative to the video stream such that the distance between the fourth virtual point and the second point of the video stream is minimized.

18. The method of claim 17, wherein the third point pair is the first point pair or the second point pair, and the fourth point pair is the first point pair or the second point pair.

19. The method of claim 17, wherein the alignment is based at least in part on an average of:
the distance between the third virtual point and the first point of the video stream is minimized, and
the distance between the fourth virtual point and the second point of the video stream is minimized.

20. A system for point cloud alignment with a floor plan or a video stream of an environment, the system comprising:
at least one scanner;
at least one memory storing instructions; and
at least one processor, wherein the at least one processor executes the instructions thereby causing the at least one processor to:
overlay a graphical representation of a point cloud onto an image of the floor plan and the video stream;
align the graphical representation of the point cloud with the image of the floor plan or the video stream using a point alignment; and
display an update of the graphical representation based at least in part on a further point alignment or a movement alignment.
